(19) United States
(12) Patent Application Publication
(10) Pub. No.: US 2004/0256557 A1
(43) Pub. Date: Dec. 23, 2004

(54) Infra-red photometric stereo

(76) Inventors: Melvyn Smith, Gloucestershire (GB); Lyndon Smith, Gloucestershire (GB)

Correspondence Address: NIXON & VANDERHYE, PC, 1100 N GLEBE ROAD, 8TH FLOOR, ARLINGTON, VA, 22201-4714, US

(21) Appl. No.: 10/484,926

(22) PCT Filed: Jul. 24, 2002
(86) PCT No.: PCT/GB02/03379

(30) Foreign Application Priority Data
Jul. 25, 2001 (GB) 0118142.9

(51) Int. Cl. G01J 5/02

(52) U.S. Cl. 250/330; 250/341.7; 250/339.01

(57) ABSTRACT

A method and apparatus for the automatic inspection of a surface is provided, the method including the steps of irradiating an area of the surface from at least two different directions using a different wavelength of electromagnetic radiation in each of the directions, and using a camera in order to recover an image of the irradiated surface, characterized in that the electromagnetic radiation is infra-red radiation.

### FIELD OF THE INVENTION

The present invention relates to a method and apparatus for the inspection of a surface. In particular, the invention relates to the use of infra-red photometric stereo for the inspection of surfaces using a single imaging device.

### BACKGROUND ART

It is desirable to be able to inspect surfaces in order to detect defects such as three-dimensional (3D) topographic features, or two-dimensional (2D) features, for example. Processes for the production of sheets of metal, timber, stone and ceramics for example, often involve the use of automatic inspection devices along the production line in order to assist quality control. In addition, it may be also be useful to obtain information on the colour of a surface, as well as that relating to defects, particularly for example, where textiles or leather are involved. Also, surfaces to be inspected are often moving, adding an extra complication to the inspection process.

Prior art methods for the inspection of such afore-mentioned surfaces are well documented and established. For example, U.S. Pat. No. 6,064,478 discloses a method and apparatus for the automatic detection of 3D defects on moving surfaces by means of colour vision systems. Also European Patent Applications EP 0 898 163 A1 and EP 1 030 173 A1 describe methods and apparatus for the automatic inspection of moving surfaces, the latter using a multiplexed approach.

The prior art systems suffer, however, from the drawback that they are unable to differentiate between the colour of a surface and the slope of the surface when using a single composite image (i.e. an image comprising two or more spatially registered channels) to isolate surface 3D features from surface 2D features, using the method of photometric stereo.

This is due to two reasons. Firstly visible light is used to illuminate the surface. When using visible light, there is a coupling between surface colour and slope. It will be impossible to determine whether certain data obtained by a camera means is due to the surface having some arbitrary colour, or whether it is due to surface slope. This problem arises due to the fact that the different components of coloured light will be reflected to the camera in differing proportions if the surface is coloured (e.g. a blue surface will absorb more light in the red end of the spectrum), or if the surface is sloped.

Secondly, the wavelengths of the light used are spaced far apart from one another (e.g. the use of red, green and blue channels dictates a separation of −100 nm between wavelengths). This further accentuates the inability of the systems to de-couple surface colour and slope.

Prior art systems overcome these problems by either assuming that the surface is monochromatic, or that a separate colour image has been previously acquired and registered with the photometric stereo images. In either case, the colour of the surface in question must be known before the photometric stereo approach may be used to recover information regarding surface slope.

A method is therefore required which overcomes the inability of prior art systems to differentiate between surface colour and slope, and which enables a surface to be examined regardless of surface colour, slope, and/or relative movement between the surface and the inspection system.

### STATEMENT OF THE INVENTION

According to one aspect of the present invention, there is provided a method for the automatic inspection of a surface, the method including the steps of:

irradiating an area of said surface from at least two different directions using a different wavelength of electromagnetic radiation in each of the said directions;

using a camera in order to recover an image of said surface, characterized in that:

the electromagnetic radiation is infra-red radiation.

Different wavelengths of infra-red radiation will typically be reflected in the same amounts, and so this allows the de-coupling of colour information from slope information. The wavelengths of radiation used are preferably in the near infra-red region of the electromagnetic spectrum.

According to a second aspect of the present invention, there is provided a method substantially as described above, but with the addition of a white light source in order to enable the capture of surface colour. This white light source may be used simultaneously with the infra-red sources.

According to a third aspect of the present invention, there is provided a software calibration means in order to effectively register three images, so that any pixel refers to the same spatial location in all of the images.

According to the present invention, there is also provided apparatus for the automatic inspection of a surface, comprising:

at least two different sources of electromagnetic radiation arranged to illuminate an area of said surface from at least two different directions;

camera means for recovering an image of said surface, characterized in that:

the wavelengths of the sources of electromagnetic radiation are closely spaced.

According to the present invention, there is also provided a portable handheld device incorporating apparatus for the automatic inspection of a surface substantially as herein described.

The present invention may advantageously be used as described in the paragraphs above on moving surfaces, as well as those which are static.

It should be emphasised that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE FIGURES

For a better understanding of the present invention and to show how the same may be carried into effect reference will now be made, by way of example, to the accompanying drawings, in which:

FIG. 1 shows an arrangement of the physical configuration of the system of the present invention including three infra-red sources and a camera;

FIG. 2 is a graph illustrating how the reflectance of a red surface varies with wavelength;

FIG. 3 shows an arrangement of the physical configuration of the system of the present invention including three infra-red illuminates, a white light source and a camera means;

FIG. 4 is a schematic representation of the camera used to give registered images in the near infra-red/infra-red regions of the spectrum (plus RGB image);

FIG. 5 is a schematic representation of apparatus used to isolate images of a surface illuminated using different infra-red sources; and

FIG. 6 shows an arrangement of the physical configuration of the system of the present invention including two infra-red sources and a camera.

### DETAILED DESCRIPTION OF THE INVENTION

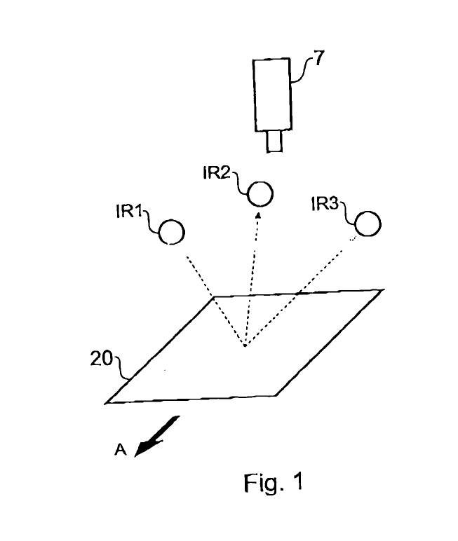

FIG. 1 shows an arrangement of the physical configuration of a preferred embodiment of the system of the present invention.

The arrangement comprises three sources of infra-red (IR) radiation IR1, IR2 and IR3, and a camera 1, all mounted above a surface 20 to be inspected. The surface 20 may be multicoloured, with 3D surface features. For example, the surface 20 may be a decorative ceramic tile.

The camera may for example be a Duncan Tech ‘3-CDD’ camera, or any other 2D array scan camera or one-dimensional (1D) line scan camera.

Embodiments of the invention having two IR sources, or more than three IR sources, are also possible. In a preferred embodiment, the wavelength of each source of radiation is located in the near infra-red (NIR) region of the spectrum, i.e. in the range 700-800 nm. The use of IR radiation allows surface colour data to be de-coupled from slope data. More specifically, the use of wavelengths of IR radiation which are narrowly spaced allows the de-coupling. For example, the three IR sources can be at wavelengths which are separated by 20 nm, at 730 nm, 750 nm and 770 nm.

Any three wavelengths (λ₁, λ₂ and λ₃ for example where λ₁<λ₂<λ₃) within the afore-mentioned region may be used, but it is preferred that |λ₁-λ₃|≦60 nm.

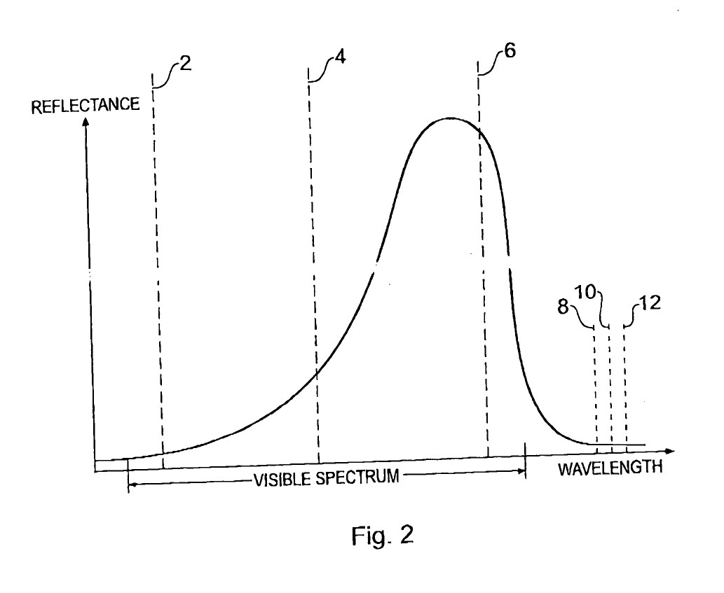

FIG. 2 is a graph which illustrates how the reflectance of light from (in this example) a red surface varies with respect to the wavelength of light incident upon the surface. Obviously, more red light is reflected, and wavelengths towards the blue end of the visible spectrum are absorbed, hence the colour of the surface. It will be appreciated that, if blue, green and red channels of visible light are used to inspect surfaces (as depicted by the lines 2, 4 and 6 respectively in FIG. 2), each wavelength will be spaced apart by −100 nm. As explained above, this therefore makes it impossible to determine whether a difference in the amount of light reflected from two channels arises because the surface is coloured, or because it is sloped at some arbitrary angle, without first knowing the surface colour. This is due to the fact that a large wavelength spacing will give rise to reflected intensities of largely differing magnitudes. Using closely spaced wavelengths in the infra-red region of the spectrum (as indicated by lines 8, 10 and 12 of FIG. 2) can at least partially overcome this problem since, in the limit as the wavelengths become closer together, slope information is entirely de-coupled from surface colour information, due to the fact that the magnitudes of the intensities of the reflected light are very close in this region.

Using electromagnetic radiation in the near-IR range, separations in the range 5-25 nm, for example 10 nm or 20 nm, are sufficiently close. At longer wavelengths in the IR range, separations of up to, say, 50 nm are sufficiently closely spaced. Equally, it is possible to use visible light at wavelengths which are spaced apart by, say, 1 nm.

Narrow wavelength spacings are preferably obtained via the use of filters in the illuminates IR1, IR2 and IR3 (e.g. narrow pass band filters or other means). The camera 7 of FIG. 1 also advantageously incorporates filters matched to those of the illuminates, in order to form a spectrally matched channel between the two. It will, however, be apparent to one skilled in the art that the method as described may not be limited to this, and for example, laser diodes or LED's may be utilised to generate radiation in the desired isolated channels.

In the arrangement of FIG. 1, the three IR illuminates and the camera may be advantageously used to inspect a surface which is moving in the direction of arrow A, as the measurements are made simultaneously and continuously on the three channels.

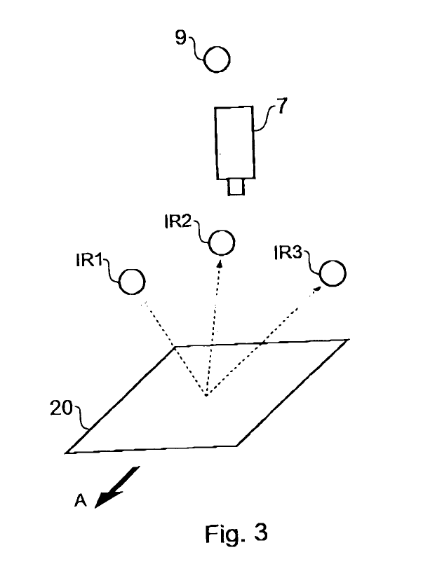

FIG. 3 shows an arrangement of a preferred embodiment in which, in addition to the three IR illuminates IR1, IR2, and IR3, there is also provided a separate white light source 9. This specifically enables the system to capture surface colour, as well as topographic information. The white light source covers the visible spectrum, and is used simultaneously with the IR illuminates. The separate white light source 9 is not required, however, for the inspection of a surface reflectance, or albedo, pattern in isolation from a surface topographic pattern.

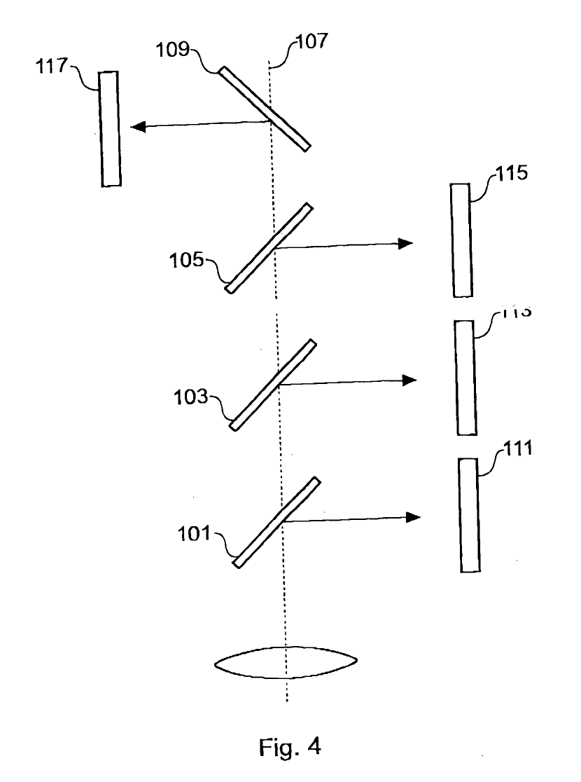

FIG. 4 shows a schematic representation of the camera used to give registered images in the near infra-red/infrared regions of the spectrum (plus RGB image). Filter 109 removes IR radiation used by the other channels from that of the white light. The filters 101, 103 and 105 are arranged along a common optical axis 107, with an additional filter 109 corresponding to the colour (RGB) channel. The elements 111, 113, 115, and 117 may be charge-coupled devices (CCD's) for example. The elements are used to produce the images relating to the RGB and IR channels. Here reference will be made to CCD's. Thus, filter 101 is matched to a filter in the first IR source IR1, and so the CCD 111 produces an image which indicates the amount of radiation from the source IR1 which is reflected along axis 107. Filter 103 is matched to a filter in the second IR source IR2, and so the CCD 113 produces an image which indicates the amount of radiation from the source IR2 which is reflected along axis 107. Filter 105 is matched to a filter in the third IR source IR3, and so the CCD 115 produces an image which indicates the amount of radiation from the source IR3 which is reflected along axis 107. CCD 117 produces an image representing the visible surface colour.

The images produced by the CCD's are then combined using a known technique so as to produce a 3D topographic image of the surface in question, highlighting surface characteristics, defects and/or surface colour. Due to the difficulty in arranging the filters to be precisely normal to the optical axis, a software calibration means is incorporated in the system as described. This effectively registers the three images, so that any pixel refers to the same spatial location in all of the images.

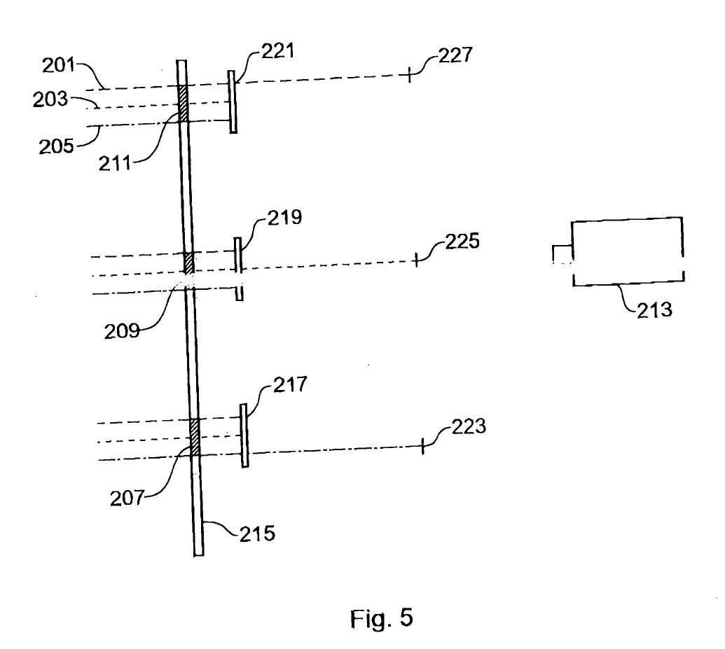

FIG. 5 shows a schematic representation of apparatus which may be used to isolate images of a surface. Lines 201, 203 and 205 represent IR radiation reflected from a surface (such as the surface 20 described above) using three separate IR sources IR1, IR2 and IR3 respectively. The reflected radiation is incident upon a 2D barrier 215 (e.g. a piece of cardboard etc). Which has has three apertures 207, 209 and 211. A camera 213 is mounted behind the barrier 215. In between the barrier 215 and the camera 213, there are arranged three filters 217, 219 and 221. Filter 217 is matched to IR source IR1, filter 219 is matched to IR source IR2, and similarly, filter 221 is matched to IR source IR3. Filter 217 is placed behind aperture 207, and similarly, filters 219 and 221 are placed behind apertures 209 and 211 respectively as depicted in FIG. 5. This results in three separate images 223, 225 and 227, slightly displaced relative to each other, incident upon camera 213. From these, an image of the surface in question may be obtained. It will be apparent to one skilled in the art that the same may be achieved by other means, for example with the use of lenses, prisms and mirrors, and also with the use of three separate imaging arrays as opposed to a single camera.

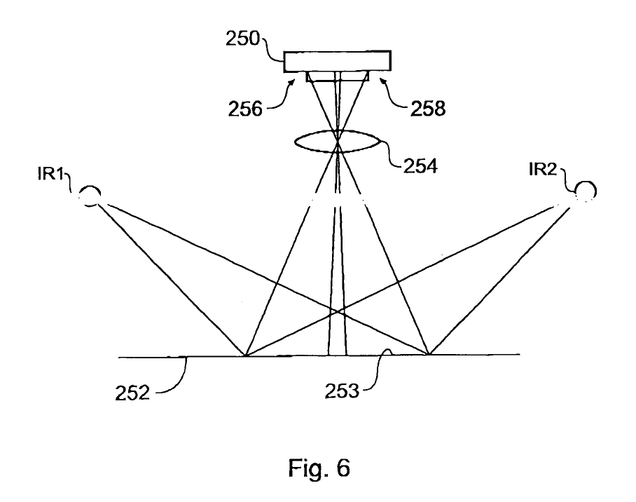

FIG. 6 shows an arrangement of the physical configuration of an embodiment of the system of the present invention. In this embodiment, two infra-red sources IR1, IR2 and a CCD camera 250 are mounted above a surface 252 to be inspected. A single region 253 of the object surface is simultaneously illuminated by the two sources, and the camera 250 is able to view the entire illuminated region through a lens 254. Instead of the camera channels viewing precisely the same location as was described before, however, two (or more) separate, but closely adjacent, parts of the same region are imaged by means of two or more small filters 256, 258 matched to the infra-red sources and placed over respective sections of the CCD camera. In this way, the channels necessary for photometric stereo are made available.

Although the present invention has been described with reference to the inspection of surfaces in the industrial sector for example, it will be apparent to the skilled artisan that the method is applicable in other areas. For example, the method could easily be applied in the medical field. More specifically, the method could be used in conjunction with endoscopes in order to recover 3D views in real-time as the endoscope is moved by the user. Still more specifically, if a diseased area has a certain colour and topographic texture, both could be isolated and displayed, the latter as a 3D graphic.

Furthermore, the system as described above could form part of a handheld portable device for the inspection of surfaces in the field. Under these circumstances, it would be the surface to be inspected that would remain stationary, with the handheld device being moved in order to perform a surface scan. This would require a method by which the range of the device from the surface to be inspected could be calculated. Such methods exist whereby either the range from the surface to the device is calculated directly using known range finding techniques, or alternatively, the range is calculated indirectly based upon an examination of the image of the surface obtained at the device. The orientation of the device with respect to the orientation of the surface may also need to be calculated.

The invention may also be applicable where only a portion of a surface is to be inspected, which portion may form a repeat unit. The use of such repeat units is desirable in, for example, computer modelling applications (in, for example, kitchen design), as an entire area may be tiled with the portion. This obviates the need for large amounts of data to be processed, and allows greater flexibility.

In addition, the invention will be applicable to situations in which the surface in question is not flat but is of arbitrary shape, and it is desirable to transform a scanned portion thereof onto another surface of arbitrary shape using known methods. For example, the detail from a curved surface may be transformed onto a two-dimensional plane for use as a repeat unit in computer models as mentioned above.

A method and apparatus for the automatic inspection of a surface using the method of photometric stereo has been described. In particular, a method and apparatus for the inspection of surfaces using infra-red photometric stereo using a single imaging device has been described.

1. Apparatus for the automatic inspection of a surface, comprising:
at least three different sources of infra-red radiation arranged to illuminate an area of said surface from respective different directions, the sources of infra-red radiation generating radiation at least at respective first, second and third wavelengths, with the second wavelength being between the first and third wavelengths, and the first and third wavelengths each being spaced from the second wavelength by 5-25 nm;
camera means for simultaneously recovering images of said surface at the three wavelengths, and for combining said images to form a topographic image of said surface.

2. The apparatus as claimed in claim 1, wherein the camera means is adapted to form an image of the albedo of the surface.

3. The apparatus as claimed in claim 1, wherein the camera means incorporates three filters, corresponding to the first, second and third wavelengths.

4. The apparatus as claimed in claim 1, wherein the sources of infra-red radiation each incorporate a respective filter.

5. The apparatus as claimed in claim 3, wherein the filters in the camera means and the sources of infra-red radiation are substantially identical, in order to provide three spectrally matched channels.

6. The apparatus as claimed in claim 1, wherein the wavelengths of the infra-red radiation are in the near infra-red region of the spectrum.

7. The apparatus as claimed in claim 1, further comprising a source of white light.

8. The apparatus as claimed in claim 1, wherein the camera means is a two-dimensional array camera.

9. The apparatus as claimed in claim 8, wherein the two-dimensional array camera is a charge coupled device (CCD).

10. The apparatus as claimed in claim 8, wherein said filters incorporated in said camera means are arranged over different portions of the two-dimensional array camera.

11. A portable handheld device incorporating the apparatus as claimed in claim 1, wherein the device includes range finding means, and means for determining the orientation of said device with respect to the orientation of said surface.

12. A method for the automatic inspection of a surface, comprising:
illuminating an area of said surface from respective different directions by means of at least three different sources of infra-red radiation, the sources of infra-red radiation generating radiation at least at respective first, second and third wavelengths, with the second wavelength being between the first and third wavelengths, and the first and third wavelengths each being spaced from the second wavelength by 5-25 nm; and
simultaneously recovering images of said surface at the three wavelengths, and for combining said images to form a topographic image of said surface.

13. The method as claimed in claim 12 further comprising forming an image of the albedo of the surface.

14. The method as claimed in claim 12, comprising obtaining the images by means of respective filters corresponding to the first, second and third wavelengths of infra-red radiation.

15. The method as claimed in claim 12, comprising illuminating the surface by means of sources of infra-red radiation which each incorporate a filter.

16. The method as claimed in claim 14, wherein the filters used to obtain the images and used in the sources of electromagnetic radiation are substantially identical.

17. The method as claimed in one of claim 12, wherein the infra-red radiation is in the near infra-red region of the spectrum.

18. The method as claimed in any of claim 12, further comprising illuminating the surface with electromagnetic radiation consisting of white light.

19. The method as claimed in claim 12, wherein the surface is moving.

20. The method as claimed in claim 12, further comprising a software calibration stage, in which the images are registered, so that any pixel refers to the same spatial location in all of the images.
